(19) United States
(12) Patent Application Publication
(10) Pub. No.: US 2008/0185045 A1
(43) Pub. Date: Aug. 7, 2008

(54) ENERGY RECOVERY APPARATUS AND METHOD

(75) Inventors: Jeffrey David Erno, Clifton Park, NY (US); Daniel Jason Erno, Clifton Park, NY (US); Patrick Jose Lazatin, Glenville, NY (US); Philip Paul Beauchamp, Rexford, NY (US); Erik John Schoepke, Bolton, MA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/671,118

(22) Filed: Feb. 5, 2007

(51) Int. Cl. F17D 1/16

(52) U.S. Cl. 137/14; 417/546; 210/136; 137/538

(57) ABSTRACT

An activatable pump is provided. The pump includes a piston in slideable communication with an inner surface of a cylinder, which has a first end and a second end. A first control valve and a second control valve are in physical communication with the first end of the cylinder. The first control valve and the second control valve are in fluid communication with the piston. Either the first control valve or the second control valve is not a check valve. A first check valve and a second check valve are in physical communication with the second end of the cylinder. The first check valve and the second check valve are in fluid communication with the piston. A pressure controller communicates with the piston to control an amount of force by or on the piston. A method and an energy recovery apparatus are also provided.

### BACKGROUND

1. Technical Field

The invention includes embodiments that relate to a pump. The invention includes embodiments that relate to an energy recovery device, a system, and a method of operating the same.

2. Discussion of Art

During a pressure interchange process, energy may be extracted from a high-pressure fluid to recover a cost associated with pressurizing the fluid. This may occur in a reverse osmosis desalination process where high-pressure seawater (feed stream) is pressed against a semi-permeable membrane. Only a portion of the feed stream becomes fresh water during this process. Because this high-pressure feed stream still has an amount of energy associated with it, it is cost effective to try to recover or recapture at least some of that energy amount.

Energy recapture may be accomplished using a turbine/compressor combination. The high-pressure fluid may impinge on a turbine wheel to drive a shaft that is in mechanical communication with a motor. In response, the motor operates a feed pump. To operate at a reasonable efficiency, the turbine operates at a high speed. High speed may exceed 15,000 revolutions per minute (rpm). For high-speed operation a reducing gearbox may be installed between the turbine unit and the feed pump motor to effectively transfer the power from the turbine to the feed pump motor. High-speed seals may be used on the shaft between the turbine and the speed-reducing gearbox.

For recovering energy, an energy recovery device may use positive displacement to allow the high-pressure feed stream to come into mechanical contact with the low-pressure feed stream in devices resembling steam piston engines. These devices may include pistons with mechanically actuated valves. Water hammer may occur when water is either suddenly stopped or accelerated. A cause may be piston movement in the process being stopped by valve closure. If the pressure or mass of the flow is significant enough, water hammer may damage the equipment.

The high-pressure fluid may need a supplemental boost to be at the correct pressure for energy recapture. Consequently, one or more additional pumps may be placed in series to achieve a correct energy recapture pressure. Each additional pump has, naturally, an undesirable economic impact associated therewith.

It may be desirable to have a system or apparatus that differs from those currently available systems or apparatuses. It may be desirable to have a method that differs from those methods that are currently available.

### BRIEF DESCRIPTION

Disclosed herein is an activatable pump comprising an embodiment of the invention. The pump includes a piston in slideable communication with an inner surface of a cylinder, which has a first end and a second end. A first control valve and a second control valve are in physical communication with the first end of the cylinder. The first control valve and the second control valve are in fluid communication with the piston. Either the first control valve or the second control valve is not a check valve. A first check valve and a second check valve are in physical communication with the second end of the cylinder. The first check valve and the second check valve are in fluid communication with the piston. A pressure controller communicates with the piston to control an amount of force by or on the piston.

Disclosed herein is a filtration system that includes the pump in fluid communication with a membrane separator. The membrane separator can remove a solute from a solvent.

Disclosed herein is a method that includes discharging a first fluid at a first pressure into a cylinder through the first control valve, wherein the first control valve is not a check valve. A piston in cylinder is moved. A second fluid at a second pressure is discharged from the cylinder through a check valve, wherein the second fluid is disposed on an opposing side of the piston from the first fluid.

### BRIEF DESCRIPTION OF FIGURES

FIG. 1 illustrates an embodiment of a pump comprising an embodiment of the invention.

FIG. 2 illustrates an embodiment of a pump having a pressure controller.

FIG. 3 illustrates an embodiment of a pump having a pressure controller includes a plurality of sliding permanent magnets and a piston includes a plurality of permanent magnets.

FIG. 4 illustrates an embodiment of a pump wherein a pressure controller includes a single sliding solenoid disposed radially about a cylinder and wherein a piston includes an electromagnet.

FIG. 5 illustrates an embodiment of a pump wherein a pressure controller includes a single sliding solenoid disposed axially about a cylinder and wherein a piston includes an electromagnet.

FIG. 6(a) illustrates an embodiment of a pump having a pressure controller that includes a plurality of stationary solenoids disposed radially about a cylinder and wherein a piston includes an electromagnet.

FIG. 6(b) is a graphical depiction of a pulsing sequence for the corresponding solenoids depicted in a FIG. 6(a).

FIG. 7(a) illustrates an embodiment of a pump having a pressure controller that includes a plurality of stationary solenoids disposed axially about a cylinder and wherein a piston includes an electromagnet.

FIG. 7(b) is a graphical depiction of a pulsing sequence for a corresponding solenoids depicted in a FIG. 7(a).

FIG. 8 illustrates one embodiment wherein the pumps are connected in series.

FIG. 9 illustrates one embodiment wherein the pumps are connected in parallel.

FIG. 10 illustrates one embodiment of a filtration system wherein a pump is in fluid communication with a membrane separator.

### DETAILED DESCRIPTION

The invention includes embodiments that relate to a pump. The invention includes embodiments that relate to an energy recovery device, a system, and a method of operating the same. Embodiments of the invention may recapture energy that would otherwise be waste.

Approximating language, as used herein throughout the specification and claims, may be applied to modify any quantitative representation that could permissibly vary without resulting in a change in the basic function to which it is related. Accordingly, a value modified by a term, such as “about”, is not limited to the precise value specified. In some instances, the approximating language may correspond to the precision of an instrument for measuring the value.

The term “operative communication” between two units indicates that the two units communicate with one another. The operative communication can be, for example, physical communication, electrical communication, mechanical communication, thermal communication (e.g., convection), acoustic communication (e.g., ultrasound, or the like), electromagnetic communication (e.g., ultraviolet radiation, optical radiation, or the like), or the like. Electrical communication includes the flow of electrons between two units, while mechanical communication involves the transfer of forces via physical contact (e.g., via friction, adhesion, or the like) between the two units. Physical communication indicates that two units may be in communication with one another without the transfer of mass or energy. It may be to be noted that two units in operative communication with one another may have more than one form of communication with one another, i.e., a first unit may be in physical communication as well as in mechanical communication with a second unit.

A magnetically or electrically activatable booster pump (hereinafter the “activatable pump”) can be used in a filtration system to extract energy from a pressurized fluid in a pressure exchange process. The activatable pump may be referred to as a work exchanger. In one embodiment, the filtration system can be used to extract energy from a pressurized feed stream during the desalination of seawater.

The magnetic field or the electrical field can control the reciprocatory movement of the piston. Such control may reduce a water hammer effect that may otherwise occur during the extraction of energy from pressurized fluids. Such reduction of the water hammer may increase the life span of the filtration system in which it may be disposed. In another embodiment, the magnetic field or the electrical field can provide supplemental energy to one or more fluid during the pressure exchange process to boost the pressure of the fluid to a membrane inlet that may be used in the filtration process.

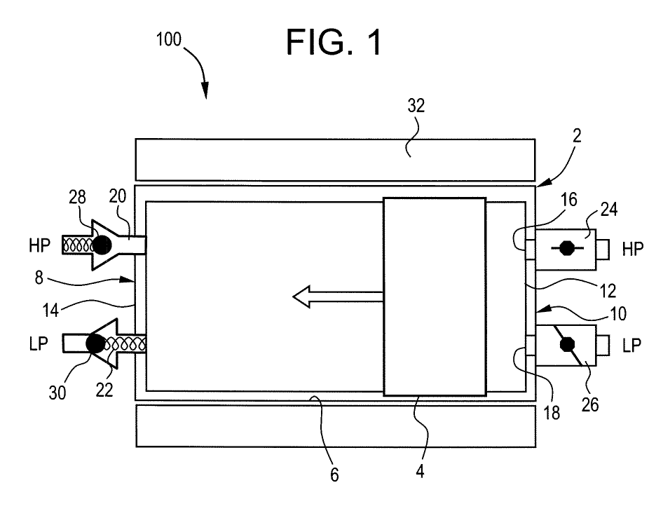

With reference to FIG. 1, an activatable pump 100 includes a cylinder 2 in which a piston 4 is disposed. The piston is in slideable communication with the cylinder. The activatable pump 100 is double acting. By double acting, a piston can compress fluid in opposing directions of travel. The cylinder includes a conduit 6 having a first end 8 and a second end 10. Both the first end and the second end are capped with a first cap 12 and a second cap 14, respectively.

The first cap defines a first port 16 and a second port 18, while the second cap defines a third port 20 and a fourth port 22. The first port 16 is in physical communication with a first control valve 24 while the second port 18 is in physical communication with a second control valve 26. The third port 20 is in physical communication with a first check valve 28, while the fourth port 22 is in physical communication with a second check valve 30. The piston is in fluid communication with the first control valve 24, the second control valve 26, the first check valve 28, and the second check valve 30.

A valve controller (not shown) controls the opening and closing of the first control valve 24 or the second control valve 26. That is, the valve controller can signal an actuator that can reversibly switch an associated valve from an open position to a closed position. In one embodiment, the valve controller is a computer. The computer is programmed to perform the functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, or the like.

The first control valve 24 and the second control valve 26 can be actuated valves that may be activated by an actuator mechanism in response to a signal from the valve controller. In one embodiment, either the first control valve 24 or the second control valve 26 is not a check valve. Activating a valve can include switching a valve from an open position to a closed position. Examples of suitable valves that can be activated by the valve controller is ball valves, butterfly valves, gate valves, sluice valves, or the like. In one embodiment, both the first control valve 24 and the second control valve 26 are butterfly valves. A suitable actuator can be, for example, a solenoid.

As shown in FIG. 1, a pressure control device or pressure controller 32 is disposed external of the cylinder and is in operative communication with the piston. The pressure control device controls an amount of force applied by or on the piston. Suitable pressure controllers can be an electrical device, a magnetic device, an electromagnetic device. The pressure controller can be disposed proximate to the cylinder. In one embodiment, the pressure controller is disposed around a circumference or peripheral edge of the conduit. In one embodiment, the pressure controller can be fully or partially concentrically disposed around the conduit.

A suitable conduit can have a cross-sectional geometry that may be circular, triangular, rectangular, square, or polygonal. The cross-sectional geometry may be measured in a direction that is perpendicular to a direction of travel of the piston. Curved surfaces can be combined with linear surfaces to form the cross-sectional geometry of the conduit. The cross-sectional geometry of the piston can correspond to the cross-sectional geometry of the cylinder and can therefore have one of the aforementioned shapes.

The piston can have a different cross-sectional area on one surface of the piston that communicates with a fluid as compared with the opposing surface of the piston that communicates with a fluid. In one embodiment, one surface of the piston may be in operative communication with a connecting rod (not shown). The connecting rod may be in operative communication with a rotating crankshaft (not shown), which promotes slideable communication of the piston with the cylinder. The operative communication of the crankshaft with the piston may be mechanical communication.

In one embodiment, the pressure controller can operate synchronously with the first control valve 24, the second control valve 26, the first check valve 28 or the second check valve 30. In another embodiment, the pressure controller can operate synchronously with only the first control valve 24 or only the second control valve 26. In another embodiment, the pressure controller can operate without reference to the first control valve 24, the second control valve 26, the first check valve 28, or the second check valve 30.

In one mode of operation, the activatable pump 100, a valve controller (not shown) signals an actuator to open the first control valve so that a first fluid at a first pressure enters the cylinder. The entrance of the first fluid into the cylinder moves the piston from the second end towards the first end. A second fluid is disposed on the opposing side of the piston from the first fluid. The piston movement from the second end to the first end compresses the second fluid in the cylinder ahead of the piston. The piston movement towards the first end may be assisted or boosted by the pressure controller.

The pressurization of the second fluid in the cylinder opens the first check valve 28, which permits the second fluid (the fluid between the piston and the first end) to discharge from the cylinder at a second pressure. Upon discharging the second fluid from the cylinder, the first check valve 28 and the first control valve 24 both may be closed by the valve controller. The opening and closing of the first check valve 28 and the first control valve 24, while occurring substantially at the same time, may be controlled independently of each other.

When the second fluid discharges from the cylinder via the first check valve 28, the second check valve 30 opens, permitting a third fluid into the cylinder. The third fluid is at a third pressure that may be less than the second pressure. The third pressure can be greater than about, equal to about, or less than about the first pressure. The entrance of the third fluid into the cylinder via the second check valve 30 urges the reverse travel of the piston towards the second end. The second control valve 26 opens during the reverse travel of the piston to permit a fourth fluid ahead of the piston to discharge from the cylinder. The fourth fluid may be disposed on the opposing side of the piston from the third fluid. The fourth fluid can be the same or different from the first fluid or the third fluid. In one embodiment, the fourth pressure that may be less than the first pressure. The fourth pressure may be less than the first pressure, the second pressure or the third pressure.

The second pressure may be greater than or equal to about the first pressure. The third pressure may be greater than or equal to about the fourth pressure. The third pressure can be greater than, equal to or less than the first pressure. In one embodiment, the third pressure may be less than the first pressure.

The first, second, third and fourth fluids may all be alike. However, some embodiments have the compositional makeup of the fluids differ from each other. In at least one embodiment, one fluid may be a feed stream to a desalination device, while another fluid may be either the brine or the dilute stream output from the desalination device.

Upon the discharging of the fourth fluid from the cylinder, the second check valve 30 and the second control valve 26 may close. The valve controller may control the opening and closing of the second control valve 26. That is, the valve controller may signal an actuator that can reversibly switch the second control valve 26 from an open position to a closed position. The opening and closing of the second check valve 30 and the second control valve 26 while occurring substantially at the same time, also occur independently of each other. During the reverse travel of the piston, the controller may be activated to promote the pumping of the fluid. The activatable pump may extract energy from the first pressurized fluid and transfer this energy to the second pressurized fluid. The reciprocatory (slideable) movement of the piston in the cylinder can be controlled by either a magnetic field, an electrical field.

Suitable pistons may include a permanent magnetic or an electromagnet. Examples of suitable materials that can be used in the production of the piston may be iron, cobalt, nickel, molybdenum, titanium, vanadium, alloys of cobalt, alloys of iron, alloys of nickel, or the like.

In one exemplary embodiment, the piston may be coated with a corrosion resistant coating layer (not shown). Corrosion resistant coatings protect the piston from degradation due to salts and other chemicals that the piston may contact. Similarly, the inner surface the defines the cylinder may be coated with a corrosion resistant coating. Corrosion resistant coatings can be metallic, ceramic or organic polymers. In one embodiment, the corrosion resistant coating may include an organic polymer. Suitable organic polymers that can be used for corrosion resistant coatings may include one or more of polysiloxanes, polyimides, polyetherimides, polyolefins, polyesters, polyacrylates, polyurethanes, polyether ether ketones, polysulfones, polyether ketones ketones, or the like. Other suitable polymers may include derivatives or blends of the foregoing. For example, a suitable halogenated polyolefin includes polytetrafluoroethylene or polyvinylidene chloride.

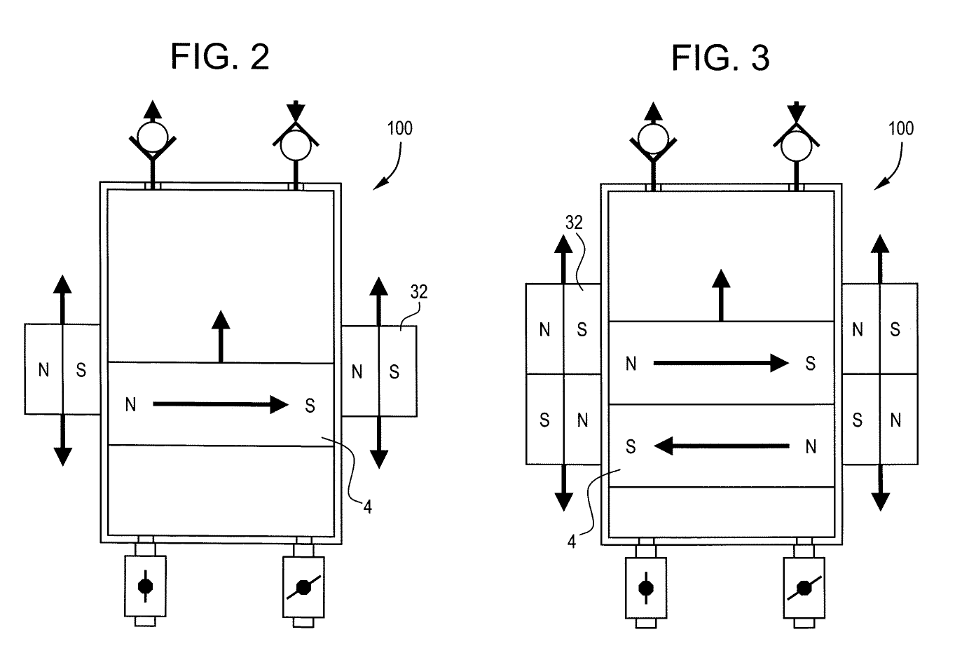

As noted above, the pressure controller can control the movement of the piston via a magnetic field or an electrical field. FIGS. 2-7 depict various embodiments of pressure controllers and their usage to control the piston movement.

In FIGS. 2 and 3, the piston may be a permanent magnet, while the pressure controller may be also a permanent magnet that may be actuated by an external device (not shown). FIG. 2 exemplifies an activatable pump in which the piston and the pressure controller include a single permanent magnet. FIG. 3 exemplifies an activatable pump in which the piston and the pressure control device both include a plurality of permanent magnets. In FIGS. 2 and 3 the movement of the piston may be slaved to or controlled by the movement of the external magnet in magnetic communication therewith.

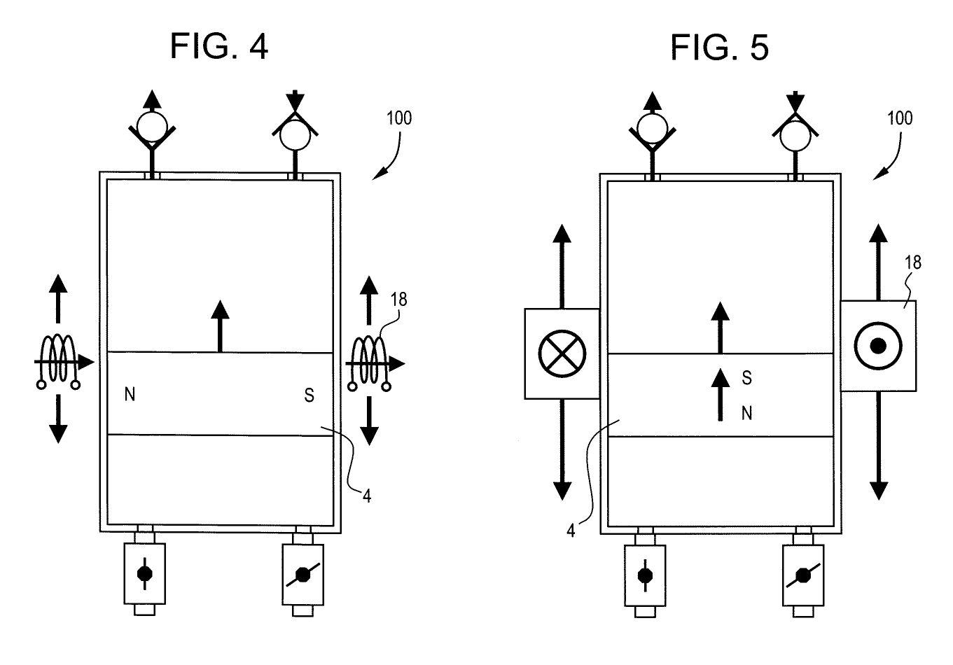

In FIGS. 4 and 5, the piston includes an electromagnet. The electromagnet may be actuated by the passage of an electrical current through a solenoid. In this case, the pressure control device may be a single solenoid. The coils of the solenoid can be arranged to be disposed radially around the cylinder as depicted in FIG. 4 or can be disposed axially around the cylinder as depicted in FIG. 5. In FIGS. 4 and 5, the movement of the solenoid may control movement of the piston. An external device similar to that used to facilitate the movement of the external magnet in FIGS. 2 and 3 may actuate the movement of the solenoid. During the movement of the solenoid, an electrical current may be simultaneously passed through the coils. The electrical current creates an electromagnetic field around the solenoid, which converts the cylinder into an electromagnet. As a result of the conversion of the cylinder into an electromagnet, when the solenoid may be moved, the piston also moves along with it.

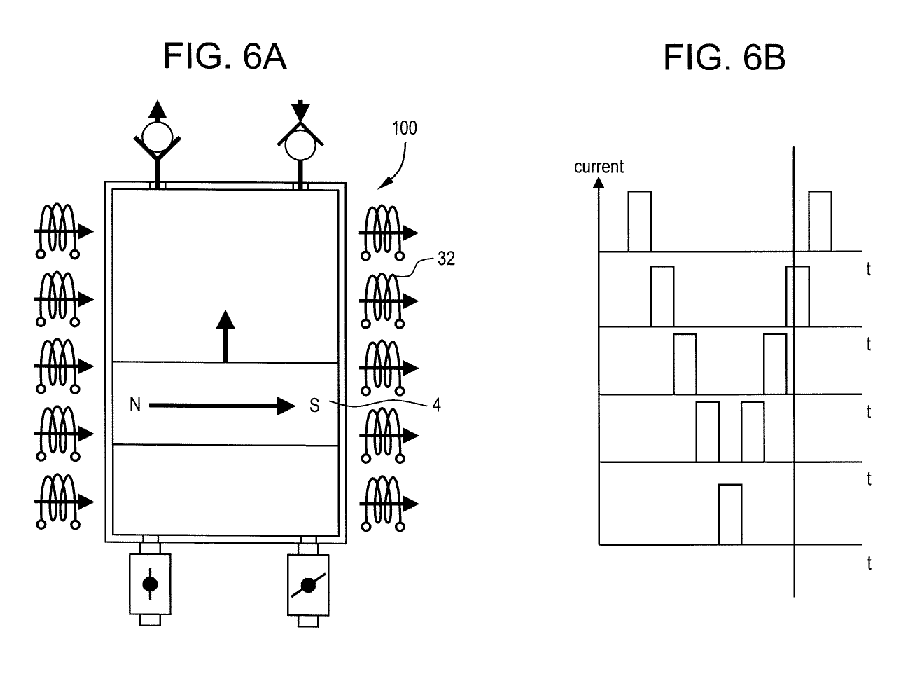

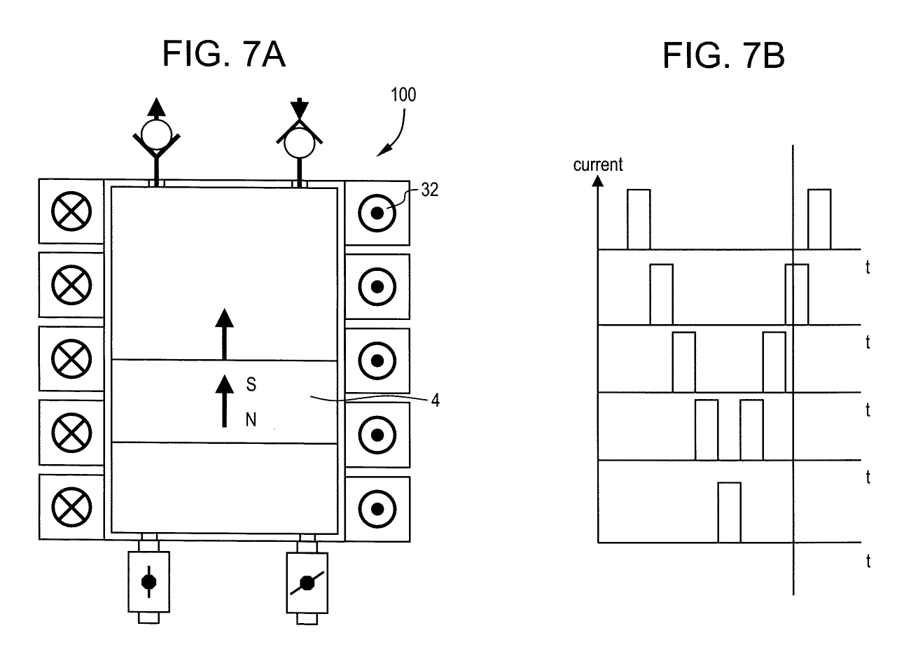

FIGS. 6 and 7 depict configurations of the activatable pump wherein a plurality of stationary solenoids may be disposed about the cylinder. FIG. 6(a) depicts a configuration wherein the plurality of stationary solenoids may be disposed radially about the cylinder, while FIG. 7(a) depicts a configuration wherein the plurality of stationary solenoids may be disposed axially about the cylinder. The plurality of solenoids are not in direct electrical communication with one another. In both FIGS. 6(a) and 7(a), the cylinder is an electromagnet.

In one mode of operation, a current may be sequentially pulsed through the adjoining solenoids depicted in FIGS. 6(a) and 7(a) respectively. FIGS. 6(b) and 7(b) graphically depict the sequential pulsing of an electrical current through the corresponding coils shown in FIGS. 6(a) and 7(a) respectively. The sequential pulsing of an electrical current through the adjacent solenoids promotes movement of the piston.

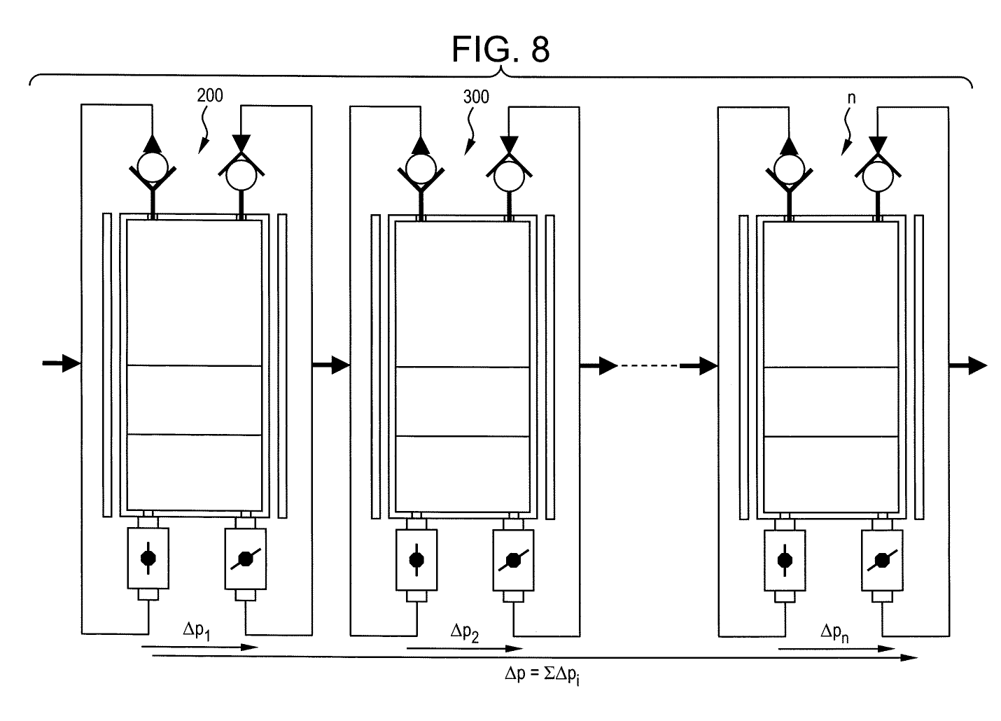

The activatable pump may be used in differing configurations. In the embodiment depicted in FIG. 8, the activatable pumps 200, 300, . . . n, can be disposed in series such that the second pressurized fluid (the highest pressurized output) from each pump forms the first pressurized fluid (input) for the succeeding activatable pump. Thus, the second pressurized fluid (Δp) of any activatable pump in the series may be the sum of the second pressurized fluid pressures (ΣΔpᵢ) from each of the preceding activatable pumps.

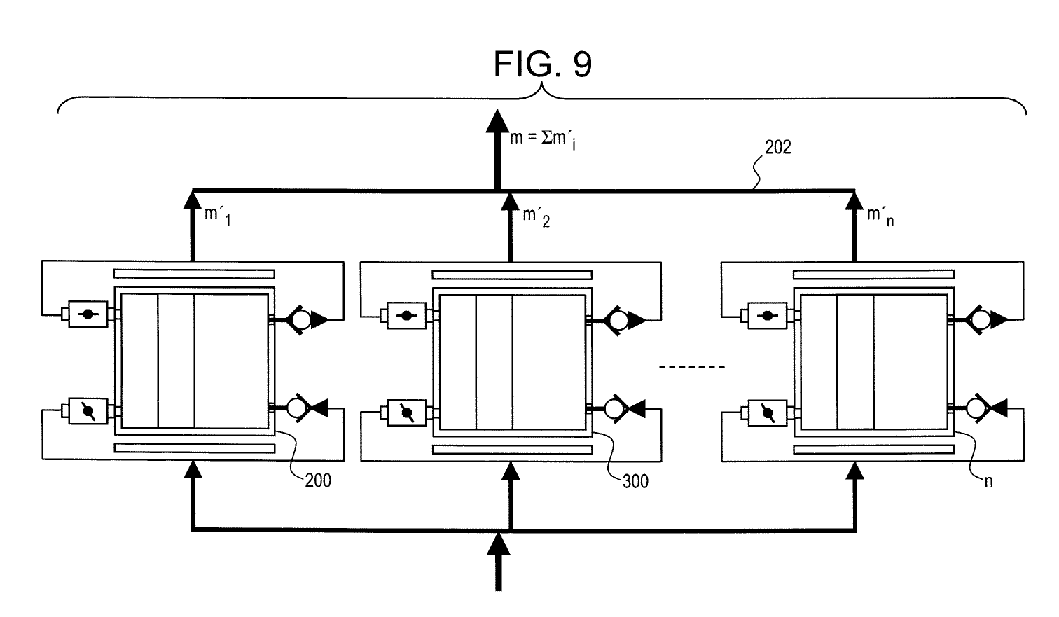

In the embodiment depicted in FIG. 9, the activatable pumps 200, 300, . . . n, can be disposed in parallel, such that the second pressurized fluid from each activatable pump may be discharged into a common pipe to form a single output 202. Such an arrangement can be used to extract energy from a large volume of pressurized fluids. The number of activatable pumps in parallel can have a swept volume that may be proportional to the volume of pressurized fluid from which it may be desired to extract energy. Thus, the total volume (or mass) discharged from the series of activatable pumps may be equal to the sum of the swept volumes (or masses) (Σm′ᵢ) of each of the activatable pumps in the arrangement. In one embodiment, the movement of the pistons can be in phase with one another. In another embodiment, the movement of the pistons can be out of phase with one another.

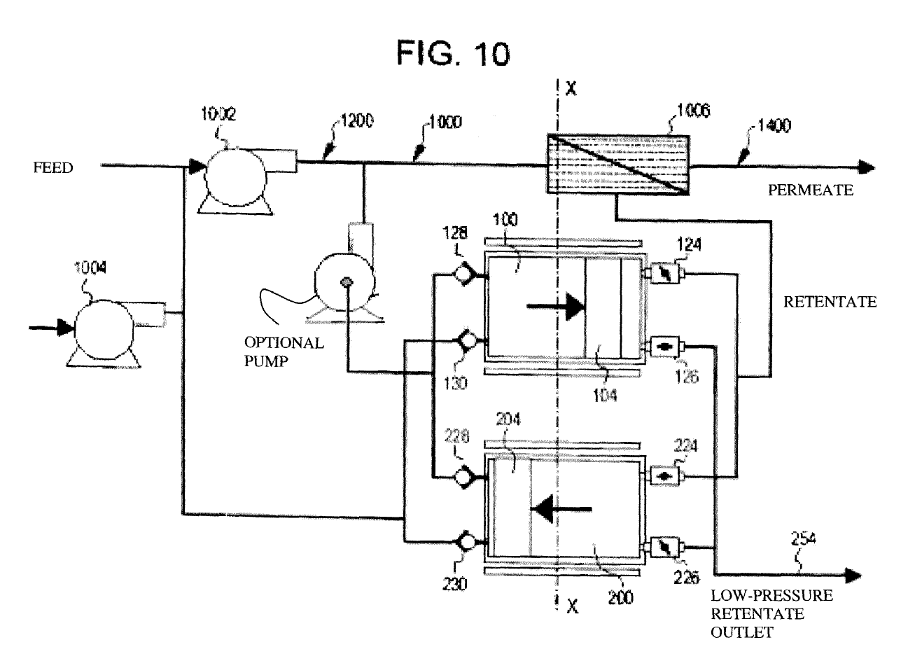

An activatable pump can be used in a filtration system 1000 as depicted in FIG. 10. The filtration system includes a feed side 1200 and a retentate side 1400. As can be seen in FIG. 10, the feed side 1200 lies to the left (when facing the viewer) of the sectional line XX, while the retentate side 1400 lies to the right of the sectional line XX.

In FIG. 10, the filtration system includes on the feed side a first pump 1002 and an optional second pump 1004, both of which may be in fluid communication with each other and with a membrane filter 1006. The first pump 1002 and the optional second pump 1004 may be also in fluid communication an activatable pump. In one embodiment, first pump 1002 and the optional second pump 1004 may be also in fluid communication with a plurality of pumps, at least one of which may be an activatable pump. In another embodiment, first pump 1002 and the optional second pump 1004 may be also in fluid communication with a plurality of activatable pumps.

The activatable pump may be in fluid communication with the membrane filter 1006. A first activatable pump 100 and a second activatable pump 200 may be disposed with their respective check valves 128, 130, 228 and 230 on the feed side 1200 of the line XX. The first activatable pump includes a first piston 104 disposed in slideable communication with a first cylinder 102, while the second activatable pump includes a second piston disposed in slideable communication with a second cylinder. The respective control valves 124, 126, 224 and 226 may be disposed on the retentate side 1400 of the line XX. The membrane filter 1006 may be in fluid communication with the first activatable pump 100 and a second activatable pump 200 via the control valves 124, 224 respectively. The control valves 126 and 226 may be in fluid communication with a low-pressure retentate outlet 254.

The first pump 1002 and the second pump 1004 are gear pumps. Other suitable pumps in other embodiments can be centrifugal pumps, rotary pumps, plunger pumps, or the like. The second pump 1004 may be a low-pressure pump that pressurizes the feed stream to a pressure of about 0.1 to about 0.2 megapascals. The first pump 1002 may be a high-pressure pump that increases the pressure on the feed stream. The pressure increase may be in an amount of greater than or equal to about 5000 megaPascals (MPa). In one embodiment, the pressure increase may be in a range of from about 5000 MPa to about 6000 MPa, from about 6000 MPa to about 7500 MPa, or greater than about 7500 MPa. An optional pump may supplement the fluid pressure in the feed side by adding a pressure boost in the stream coming from the check valves 128, 228 to the membrane filter 1006.

The filtration system can be used for separating a solute from a solvent. The filtration system can desalinate salt water. In a desalination process, a feed stream water solution may be separated by a membrane filter into a permeate and a retentate. If the feed stream water solution is seawater, the permeate may be water and the retentate may be brine. The membrane filter facilitates desalination of the feed stream to produce a permeate (water that has a lower content of salts than seawater) and a retentate (brine solution that may be higher in salt content than the seawater).

In one mode of operation, the first pump 1002 discharges feed stream towards the membrane filter 1006. A portion of the feed stream may convert into permeate upon undergoing filtration in the membrane filter 1006, while the remaining feed stream may be converted into retentate and discharged into the first activatable pump 100 upon the opening of the first control valve 124. The valve controller (not shown) can control the opening and closing of the control valves 124, 126, 224 and 226 independently of each other, or, if desirable, with some relation to each other.

As the pressurized retentate at a first pressure enters the cylinder of the first activatable pump 100, the respective pressure controller may be activated to provide a boost in force to the first piston 104 during its travel towards the first check valve 128. The increase in force on the first piston 104 increases the pressure on the feed stream between the first piston 104 and the first check valve 128 to a second pressure. The second pressure may be greater than the first pressure. Upon being discharged through the first check valve 128, the feed stream may be directed into the membrane filter 1006 to undergo filtration and be formed into streams that are the permeate and the retentate.

The first activatable pump 100 provides a boost in pressure to the feed stream that improves the efficiency of the desalination process. In addition, by controlling the force on the piston through the pressure controller, water hammer can be minimized.

After the feed stream at the second pressure discharges from the cylinder of the first activatable pump 100, the low-pressure feed stream at a third pressure may be drawn into the cylinder of the first activatable pump via the second check valve 130. The low pressure feed stream drives the piston away from the check valves 128, 130 towards the control valves 124, 126, discharging the retentate from the cylinder at a fourth pressure into the low-pressure retentate outlet 254.

In the embodiment depicted in FIG. 10, while the first piston 104 of the first activatable pump travels in a first direction from the control valves towards the check valves to discharge feed stream, the second piston 204 of the second activatable pump 200 travels in a second direction from the check valves towards the control valves. The second direction may be opposed to the first direction. In other words, the first activatable pump 100 and the second activatable pump 200 work asynchronously, such that while the first activatable pump 100 may be pressurizing the feed stream to the second pressure, the second activatable pump 200 may be discharging low pressure retentate at the fourth pressure to the low pressure retentate outlet 254. Alternatively, when the second activatable pump 200 may be pressurizing the feed stream to the first pressure, the first activatable pump 100 may be discharging low-pressure retentate at the fourth pressure to the low-pressure retentate outlet 254.

With reference to FIG. 10, the filtration system 1000 includes two activatable pumps 100, 200. In the event that the activatable pumps may be in communication with the first pump 1002 and the membrane filter 1006, the respective pistons for each pump operate either in phase with one another. In one embodiment, the respective pistons 104, 204 operate 180 degrees out of phase with one another. The first piston 104 can be at one end of its travel and has discharged the entire feed stream in the activatable pump 100 to the membrane filter 1006, while the piston 304 can be at the opposing end of its travel and have discharged all of the retentate to the low-pressure retentate outlet 254. The piston 204 can be at the center of its travel in either direction and can therefore either be discharging feed stream to the membrane filter 1006 or can be discharging retentate towards the low-pressure retentate outlet 254.

In an alternative embodiment, a filtration system may include three or more activatable pumps; at least two of the pumps may communicate with the feed stream to the membrane filter. One or more of the plurality of pumps operate out of phase from at least one other of the pumps. In one embodiment, the pumps operate 120 degrees out of phase with one another. A plurality of filtration systems can be disposed in parallel with one another. This arrangement permits a relatively larger volume of feed stream to desalinate in a period.

The activatable pump can vary the amount of pressure boost provided to the feed stream. The pump may minimize or eliminate the effects of water hammer thereby reducing down time used for maintenance of valves and other equipment. This facilitates improved cycle times and productivity. In addition, the use of the activatable pump in the filtration system results in a reduction in the number of other types of pumps (e.g., centrifugal pumps, gear pumps, rotary pumps, plunger pumps, or the like) that need to be utilized. A system according to one embodiment can function by employing only a single first pump 1002, thus reducing the cost of new equipment as well as reducing the cost of long term maintenance.

The embodiments described herein are examples of structures, systems and methods having elements corresponding to the elements of the invention recited in the claims. This written description may enable those of ordinary skill in the art to make and use embodiments having alternative elements that likewise correspond to the elements of the invention recited in the claims. The scope of the invention thus includes structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

What is claimed is:

1. An activatable pump comprising:
a piston in slideable communication with an inner surface of a cylinder, which has a first end and a second end;
a first control valve and a second control valve in physical communication with the first end of the cylinder, wherein the first control valve and the second control valve are in fluid communication with the piston, and at least the first control valve or the second control valve is not a check valve;
a first check valve and a second check valve in physical communication with the second end of the cylinder, wherein the first check valve and the second check valve is in fluid communication with the piston; and
a pressure controller operable to control an amount of force exerted on the piston or by the piston.

2. The activatable pump as defined in claim 1, wherein the cylinder comprises a permanent magnet or an electromagnet.

3. The activatable pump as defined in claim 1, wherein at least one of the first control valve and the second control valve communicate with a valve controller.

4. The activatable pump as defined in claim 1, wherein the piston is in operative communication with a connecting rod.

5. The activatable pump as defined in claim 1, wherein the piston comprises a corrosion resistant layer.

6. The activatable pump as defined in claim 1, wherein the first control valve or the second control valve function synchronously with the pressure controller.

7. The activatable pump as defined in claim 1, wherein the first control valve or the second control valve function independently of the pressure controller.

8. The activatable pump as defined in claim 1, wherein the pressure controller comprises a magnetic device, an electrical device, or an electromagnetic device.

9. The activatable pump as defined in claim 1, wherein the pressure controller comprises a permanent magnet.

10. The activatable pump as defined in claim 1, wherein the pressure controller comprises a solenoid.

11. The activatable pump as defined in claim 10, wherein the solenoid comprises one or more coils that are radially or axially disposed about the cylinder.

12. The activatable pump as defined in claim 1, wherein the pressure controller comprises a plurality of solenoids that are radially or axially disposed about the cylinder.

13. The activatable pump as defined in claim 1, wherein the first control valve or the second valve is a butterfly valve, a gate valve, a sluice valve, or a gate valve.

14. An energy recovery apparatus comprising a plurality of activatable pumps as defined in claim 1.

15. A filtration system comprising:
the pump as defined in claim 1 in fluid communication with a membrane separator, wherein the membrane separator can contact a solute-bearing solution and separate the solute from a solvent of the solution.

16. The filtration system as defined in claim 15, comprising a second pump in fluid communication with the membrane separator and the first activatable pump.

17. The filtration system as defined in claim 16, wherein the second pump is an activatable pump.

18. The filtration system as defined in claim 16, wherein the second pump is an activatable pump that works asynchronously with the first pump.

19. The filtration system as defined in claim 15, further comprising a plurality of activatable pumps, each of which are in fluid communication with the membrane separator and the first activatable pump.

20. The filtration system as defined in claim 19, wherein each of the plurality of activatable pumps work asynchronously with each other.

21. The filtration system as defined in claim 19, further comprising a first pump in fluid communication with the membrane filter and with the first activatable pump.

22. The filtration system as defined in claim 19, further comprising a second pump in fluid communication with the membrane filter and with the first activatable pump.

23. A method, comprising:
opening a first control valve to discharge a first fluid at a first pressure into a volume defined by an inner surface of a cylinder, wherein the first control valve is not a check valve;
displacing a piston disposed in the cylinder; and
discharging a second fluid that is disposed on an opposing side of the piston relative to the first fluid from the cylinder through a check valve and at a second pressure that differs from the first pressure.

24. The method as defined in claim 23, further comprising discharging a third fluid at a third pressure into the cylinder through a second check valve, displacing the piston, and discharging a fourth fluid at a fourth pressure from the cylinder through a second control valve.

25. The method as defined in claim 24, wherein the third fluid differs from the fourth fluid and wherein the third pressure is greater than or equal to the fourth pressure.

26. The method as defined in claim 25, wherein the third fluid is a feed stream and the fourth fluid is a retentate.

27. The method as defined in claim 23, wherein the first fluid is a retentate and the second fluid is a feed stream.

28. The method as defined in claim 27, further comprising discharging the second fluid into a membrane separator.

29. The method as defined in claim 28, wherein the feed stream is seawater and the retentate is brine.

30. The method as defined in claim 28, further comprising converting the cylinder into an electromagnet.

31. An energy recovery apparatus, comprising:
means for discharging a first fluid at a first pressure into a cylinder, wherein the discharging means is not a check valve;
means for displacing a piston disposed in the cylinder; and
means for discharging a second fluid that is disposed on an opposing side of the piston relative to the first fluid from the cylinder through a check valve and at a second pressure that differs from the first pressure.

32. The apparatus as defined in claim 31, wherein the displacing means comprises a solenoid.
